(19) United States
(12) Patent Application Publication
(10) Pub. No.: US 2024/0415172 A1
(43) Pub. Date: Dec. 19, 2024

(54) AEROSOL-GENERATING ARTICLE FOR INDUCTIVELY HEATED DEVICE

(71) Applicant: PHILIP MORRIS PRODUCTS S.A., Neuchatel (CH)

(72) Inventors: Rui Nuno Rodrigues Alves Batista, Morges (CH); Alexandra Sereda, Neuchatel (CH); Anzhelika Simonyan, Yerevan (AM)

(21) Appl. No.: 18/700,830

(22) PCT Filed: Oct. 19, 2022
(86) PCT No.: PCT/EP2022/079030

§ 371 Date: Apr. 12, 2024

(30) Foreign Application Priority Data
Oct. 20, 2021 (AM) AM20210082

(51) Int. Cl. A24F 40/10; A24F 40/44; A24F 40/465; A24F 40/48

(52) U.S. Cl. CPC A24F 40/10; A24F 40/44; A24F 40/465; A24F 40/48

(57) ABSTRACT

The invention relates to an aerosol-generating article for use with an aerosol-generating device. The article comprises a susceptor element (32) comprising a hollow tubular proximal region (34) and a closed distal end (36). The article comprises a hollow tubular wick element (42) coaxially circumscribing at least a portion of the hollow tubular proximal region of the susceptor element. The invention further relates to an aerosol-generating system.

The present disclosure relates to an aerosol-generating article for an aerosol-generating device. The present disclosure further relates to an aerosol-generating system comprising an aerosol-generating device and an aerosol-generating article.

It is known to provide an aerosol-generating device for generating an inhalable vapor. Such devices may heat an aerosol-forming substrate contained in an aerosol-generating article without burning the aerosol-forming substrate. The heating arrangement may be an induction heating arrangement and may comprise an induction coil and a susceptor. The susceptor may be part of the device or may be part of the article.

The aerosol-generating article may have a shape suitable for insertion of the aerosol-generating article into a heating chamber of the aerosol-generating device. For example, the aerosol-generating article may have a rod shape. A heating element may be arranged in or around the heating chamber for heating the aerosol-forming substrate once the aerosol-generating article is inserted into the heating chamber of the aerosol-generating device. Upon heating to a target temperature, the aerosol-forming substrate vaporises to form an aerosol.

The aerosol-generating article may comprise a solid aerosol-forming substrate. Alternatively, a liquid aerosol-forming substrate may be delivered from a liquid storage portion to an electrical heating element. The liquid substrate may be delivered to the heating element via a capillary component. The liquid storage portion may be formed as a replaceable or a refillable cartridge comprising a liquid aerosol-forming substrate. The cartridge may be attached to the aerosol-generating device for supplying the liquid aerosol-forming substrate to the device for aerosol generation.

It would be desirable to provide an aerosol-generating article comprising a liquid aerosol-forming substrate. It would be desirable to provide an aerosol-generating article comprising a liquid aerosol-forming substrate that can be used with an existing inductively heated aerosol-generating device configured for inductively heating an aerosol-generating article comprising a solid aerosol-forming substrate. It would be desirable to provide a compact aerosol-generating article comprising a liquid aerosol-forming substrate. It would be desirable to provide an aerosol-generating article comprising a liquid aerosol-forming substrate with leakage prevention.

According to an embodiment of the invention there is provided an aerosol-generating article for use with an aerosol-generating device. The article may comprise a susceptor element. The susceptor element may comprise a hollow tubular proximal region. The susceptor element may comprise a closed distal end. The article may comprise a hollow tubular wick element. The hollow tubular wick element may coaxially circumscribe at least a portion of the hollow tubular proximal region of the susceptor element.

According to an embodiment of the invention there is provided an aerosol-generating article for use with an aerosol-generating device. The article comprises a susceptor element comprising a hollow tubular proximal region and a closed distal end. The article comprises a hollow tubular wick element coaxially circumscribing at least a portion of the hollow tubular proximal region of the susceptor element.

An aerosol-generating article is provided which may be designed compact to fit into a narrow heating chamber of an aerosol-generating device which is also designed for inductively heating a tobacco-containing consumable. Such consumables typically have an outer diameter of 5 millimeter to 10 millimeters, preferably of 6 millimeters to 8 millimeters. The hollow heating chamber has a slightly wider internal diameter compared to the outer diameter of the consumable.

The closed distal end of the aerosol-generating article may assist in leakage prevention. Liquid droplets which may be present inside the hollow tubular proximal region, for example, due to a portion of liquid aerosol-forming substrate that has not been evaporated or that has re-condensed as a droplet at an internal wall, may travel towards the closed distal end by gravity or capillary forces. The liquid droplets may be hindered by the closed distal end to exit the susceptor. Thereby, leakage may be avoided.

The closed distal end may be fluid impermeable.

The closed distal end may be configured as a cup-shaped distal end region.

The cup-shaped distal end region may provide a collecting reservoir for collecting condensed liquid droplets.

The cup-shaped distal end region may provide a mechanism for leakage prevention. Liquid droplets which may be present inside the hollow tubular proximal region, for example, due to a portion of liquid aerosol-forming substrate that has not been evaporated, may travel towards the cup-shaped distal end region by gravity or capillary forces. The liquid droplets may then be trapped in the collecting reservoir. Thereby, leakage may be avoided.

At least a portion of the susceptor element may be fluid permeable. At least a portion of the hollow tubular proximal region of the susceptor element may be fluid permeable. At least a portion of the hollow tubular proximal region of the susceptor element may be fluid permeable and the closed distal end may be fluid impermeable.

One or both of the hollow tubular proximal region and the closed distal end of the susceptor element may comprise a porous susceptor material.

The porous susceptor material may have a porosity of 45% to 80%, preferably 55% to 70%.

As used herein, the ‘porosity’ is defined as the percentage of a unit volume which is void of material. The porosity is may be derived using standard method and equation giving a decimal value for porosity. Knowing the pore volume of a defined volume of material (Vp) and its total volume (Vt), porosity (Pt) is given by the ratio Vp/Vt. To express porosity as a percent, that decimal is simply multiplied by 100%. For example, Pt=0.51, therefore 0.51×100%=51%.

The porous susceptor material may be a ferromagnetic alloy, preferably a ferromagnetic stainless steel alloy, more preferably 304 stainless steel, or 410 stainless steel.

The hollow tubular proximal region and the closed distal end of the susceptor element may form a monolithic structure.

The entire susceptor element comprising the tubular proximal region and the closed distal end may be a monolithic structure. The monolithic structure may be fluid permeable. The monolithic structure may be porous. The monolithic structure may comprise a fluid impermeable coating in the area of the closed distal end.

The aerosol-generating article may comprise an airflow path extending along a longitudinal center axis of the hollow tubular proximal region of the susceptor element.

The aerosol-generating article may comprise one or more air inlets located at a position proximal to the closed distal end.

The size, number, and arrangement of the one or more air inlets may be configured to predetermine the overall resistance to draw of the aerosol-generating article.

During use, when the aerosol-generating article is inserted into an aerosol-generating device, the retention to draw, also called resistance to draw (RTD), of the aerosol-generating article may be in the range of between 50 to 200 mm of water, preferably between 100 and 160 mm of water, more preferably between 120 and 140 mm of water.

The one or more air inlets may be are arranged such that the overall resistance to draw of the aerosol-generating article is in the range of between 50 to 200 mm of water, preferably between 100 and 160 mm of water, more preferably between 120 and 140 mm of water.

The wick element may be a monolithic element.

The wick element may comprise a ceramic material. The wick element may comprise a porous material. The wick element may comprise a porous ceramic material. The wick element may comprise porous silica ceramics. The porosity of the sintered material can be adjusted by changing the content of the introduced silica particles, changing its granulometry, which enables to well control the desired porosity of the final product.

The porosity of the wick element may be 45% to 80%, preferably 50% to 65%, most preferably 50% to 60%.

The aerosol-generating article may comprise a hollow tubular liquid storage portion coaxially circumscribing the wick element. The liquid storage portion may comprise one or both of a liquid aerosol-forming substrate and a liquid sensorial media. The liquid aerosol-forming substrate or the liquid sensorial media may comprise nicotine. The liquid aerosol-forming substrate or the liquid sensorial media may comprise a botanical content, for example CBD.

The hollow tubular liquid storage portion may comprise a high-retention material adjacent to a side wall of the wick element. The high retention material be provided in the form of a hollow tubular element coaxially circumscribing the wick element. An outer diameter of the hollow tubular element of the high-retention material may be between 4 millimeters and 6.5 millimeters. The high-retention material may be a porous material. The high-retention material may comprise cotton. The high-retention material may comprise a capillary material as described herein. The high-retention material may help in assuring wettability of the wick element. The high-retention material may help in assuring that the wick element is fed with liquid from the liquid storage portion at all times.

The aerosol-generating article may comprise a fluid permeable wall element provided at an interface between the high-retention material and the wick element. The aerosol-generating article may comprise a porous wall element provided at an interface between the high-retention material and the wick element. The porosity of the wall element may be between 50% and 90%, preferably between 50% and 80%.

The aerosol-generating article may comprise a mouthpiece or mouthpiece element. The mouthpiece or mouthpiece element may comprise a homogenization chamber. The homogenization chamber may enable one or both of expansion, homogenization and cooling of the aerosol before it exits the mouthpiece element for inhalation by a user.

The mouthpiece may comprise a tubular core element. The tubular core element may be configured for reducing condensation formation. The tubular core element may comprise a tubular wall. The tubular core element may be arranged in the centre of the mouthpiece. The tubular core element may be arranged at the longitudinal axis of the aerosol-generating article. The tubular core element may have an inner diameter measured in a direction orthogonal to the longitudinal axis of the aerosol-generating article. The inner diameter of the tubular core element of the mouthpiece may be smaller than the inner diameter of the outer tubular wall of the mouthpiece. The inner diameter of the tubular core element may be about a third of the diameter of the mouthpiece. The tubular core element of the mouthpiece may have a length measured in a direction along the longitudinal axis of the aerosol-generating article. The length of the tubular core element may be smaller than a length of the mouthpiece, measured in the same direction. The length of the tubular core element may be about half the length of the mouthpiece. After exiting the tubular core element, the speed of the aerosol flow may decrease. The aerosol may be further homogenized after exiting the tubular core element. The inner side of the tubular wall of the tubular core element may be exposed to higher temperatures then the outside of the tubular wall. The tubular core element may prevent or reduce condensation formation. Condensation of the aerosol and droplet formation on the inside of the tubular wall of the tubular core element may be prevented or reduced. During use, the tubular wall of the tubular core element may have a higher temperature than the outer tubular wall of the mouthpiece. Thereby, condensation formation may be prevented or reduced.

The mouthpiece may comprise a high-retention material configured for condensation prevention. As used herein, a “high-retention material” is a material that is capable of absorbing and/or storing liquid (for example, aqueous liquid) and is capable of conveying the liquid (for example, by capillary action). For example, the liquid may be conveyed away from the inner side of the outer tubular wall of the mouthpiece. Liquid aerosol-forming substrate or liquid residues of the aerosol-forming substrate may condensate on an inner side of the outer tubular wall of the mouthpiece. The high-retention material may surround the tubular core element of the mouthpiece. The high-retention material may surround a distal portion of the tubular core element of the mouthpiece. Thereby, condensate may be absorbed when the aerosol-generating article is oriented an upright position with the distal end facing towards the center of gravity. The high-retention material may for example be cotton.

The mouthpiece element may comprise one or more peelable outer layers.

The aerosol-generating article may have a cylindrical shape. An outer diameter of the article may be between 5 millimeters to 10 millimeters, preferably between 6 millimeters to 8 millimeters.

The aerosol-generating article may comprise a proximal sealing element at a proximal end of the wick element. The aerosol-generating article may comprise a distal sealing element at a distal end of the wick element. One or both of the proximal sealing element and the distal sealing element may be in the form of a sealing disk. One or both of the proximal sealing element and the distal sealing element may block air, and may retain and assemble the susceptor element and the wick element.

The aerosol-generating article may comprise a capping element arranged at a distal end thereof. The capping element may comprise a hollow tubular wall element. The capping element may comprise one or more recesses circumferentially arranged at a distal end of the hollow tubular wall element. The capping element may comprise one or more inlet holes, preferably elongate openings, circumferentially arranged in the hollow tubular wall element.

The recesses or inlet holes may allow for ambient air to enter the article at its distal end thereof when the article is brought into contact to a planar surface, for example, when the article is inserted into a heating chamber of an aerosol-generating device and against a plane distal base of the heating chamber.

The present invention further relates to an aerosol-generating system comprising an aerosol-generating article as described herein and an aerosol-generating device. The aerosol-generating device comprises a heating chamber for insertion of at least a portion of the article and an inductor coil at least partly circumscribing the heating chamber for inductively heating the aerosol-generating article.

The liquid storage portion of the aerosol-generating article may comprise one or both of a liquid aerosol-forming substrate and a liquid sensorial media. The liquid sensorial media may comprise a flavorant. The liquid sensorial media may comprise nicotine. The liquid aerosol-forming substrate or liquid sensorial media may comprise a flavoring, for example menthol or herbal compounds. The liquid aerosol-forming substrate or the liquid sensorial media may comprise nicotine. The liquid aerosol-forming substrate or the liquid sensorial media may comprise a botanical content, for example CBD.

The wick element may comprise cotton. The wick element may be made of cotton.

The wick element may be a porous element. The wick element may be capable of absorbing liquid from the airflow. The wick element may comprise a capillary material. The capillary material may have a fibrous or spongy structure. The capillary material preferably comprises a bundle of capillaries. For example, the capillary material may comprise a plurality of fibres or threads or other fine bore tubes. The fibres or threads may be generally aligned to convey liquid from the distal part of the wick element to the proximal part of the wick element. Alternatively, the capillary material may comprise sponge-like or foam-like material. The structure of the capillary material may form a plurality of small bores or tubes, through which the liquid can be transported by capillary action. The capillary material may comprise any suitable material or combination of materials. Examples of suitable materials are a sponge or foam material, ceramic- or graphite-based materials in the form of fibres or sintered powders, foamed metal or plastics materials, a fibrous material, for example made of spun or extruded fibres, such as cellulose acetate, polyester, or bonded polyolefin, polyethylene, ethylene or polypropylene fibres, nylon fibres or ceramic. The capillary material may have any suitable capillarity and porosity so as to be used with different liquid physical properties. The liquid has physical properties, including but not limited to viscosity, surface tension, density, thermal conductivity, boiling point and vapour pressure, which allow the liquid to be transported through the capillary material by capillary action. The capillary material may be configured to convey the aerosol-forming substrate to the proximal part of the wick element and to the susceptor element. The capillary material may extend into interstices in the susceptor element.

As used herein the term ‘liquid sensorial media’ relates to a liquid composition capable of modifying an airflow in contact with the liquid sensorial media. The modification of the airflow may be one or more of forming an aerosol or a vapor, cooling an airflow, and filtering an airflow. For example, the liquid sensorial media may comprise an aerosol-forming substrate capable of releasing volatile compounds that can form an aerosol or a vapor. Preferably, the aerosol-forming substrate in the liquid sensorial media is a flavorant or comprises a flavorant. Alternatively or in addition, the liquid sensorial media may comprise one or both of a cooling substance for cooling an airflow passing through the liquid sensorial media and a filter substance for capturing unwanted components in the airflow. Water may be used as a cooling substance. Water may be used as a filtering substance for capturing particles such as dust particles from the airflow. The liquid sensorial media may serve as one or more of a nicotine providing liquid, a flavor enhancer, and a volume enhancer.

As used herein, the term ‘aerosol-forming substrate’ relates to a substrate capable of releasing volatile compounds that can form an aerosol or a vapor. Such volatile compounds may be released by heating the aerosol-forming substrate. The aerosol-forming substrate may be in solid form or may be in liquid form. The terms ‘aerosol’ and ‘vapor’ are used synonymously.

The aerosol-forming substrate may be part of an aerosol-generating article. The aerosol-forming substrate may be part of the liquid held in the liquid storage portion of the aerosol-generating article. The aerosol-forming substrate may be part of the liquid sensorial media held in the liquid storage portion of the aerosol-generating article. The liquid storage portion may contain a liquid aerosol-forming substrate. Alternatively or in addition, the liquid storage portion may contain a solid aerosol-forming substrate. For example, the liquid storage portion may contain a suspension of a solid aerosol-forming substrate and a liquid. Preferably, the liquid storage portion contains a liquid aerosol-forming substrate.

Preferably, a liquid nicotine or flavor/flavorant containing aerosol-forming substrate may be employed in the liquid storage portion of the aerosol-generating article.

The aerosol-forming substrate may comprise nicotine. The nicotine-containing aerosol-forming substrate may be a nicotine salt matrix.

The aerosol-forming substrate may comprise plant-based material. The aerosol-forming substrate may comprise tobacco. The aerosol-forming substrate may comprise a tobacco-containing material including volatile tobacco flavour compounds which are released from the aerosol-forming substrate upon heating. Alternatively, the aerosol-forming substrate may comprise a non-tobacco material. The aerosol-forming substrate may comprise homogenised plant-based material. The aerosol-forming substrate may comprise homogenised tobacco material. Homogenised tobacco material may be formed by agglomerating particulate tobacco.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the device. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as triethylene glycol, 1, 3-butanediol. Preferably, the aerosol former is glycerine. Where present, the homogenised tobacco material may have an aerosol-former content of equal to or greater than 5 percent by weight on a dry weight basis, and preferably from 5 percent to 30 percent by weight on a dry weight basis. The aerosol-forming substrate may comprise other additives and ingredients, such as flavourants.

As used herein, the term ‘aerosol-generating article’ refers to an article comprising an aerosol-forming substrate that is capable of releasing volatile compounds that can form an aerosol. For example, an aerosol-generating article may be an article that generates an aerosol that is directly inhalable by the user drawing or puffing on a mouthpiece at a proximal or user-end of the device. An aerosol-generating article may be disposable. The aerosol-generating article may be insertable into the heating chamber of the aerosol-generating device.

As used herein, the term ‘liquid storage portion’ refers to a storage portion comprising a liquid sensorial media and, additionally or alternatively, an aerosol-forming substrate that is capable of releasing volatile compounds that can form an aerosol. The liquid storage portion may be configured as a container or a reservoir for storing the liquid aerosol-forming substrate.

The liquid storage portion may be configured as a replaceable tank or container. The liquid storage portion may be any suitable shape and size. For example, the liquid storage portion may be substantially cylindrical. The cross-section of the liquid storage portion may, for example, be substantially circular, elliptical, square or rectangular.

As used herein, the term ‘aerosol-generating device’ refers to a device that interacts with one or both of an aerosol-generating article and a cartridge to generate an aerosol.

As used herein, the term ‘aerosol-generating system’ refers to the combination of an aerosol-generating device with one or both of a cartridge and an aerosol-generating article. In the system, the aerosol-generating device and one or both of the aerosol-generating article and the cartridge cooperate to generate a respirable aerosol.

Preferably, the aerosol-generating device is portable. The aerosol-generating device may have a size comparable to a conventional cigar or cigarette. The device may be an electrically operated smoking device. The device may be a handheld aerosol-generating device. The aerosol-generating device may have a total length between 30 millimetres and 150 millimetres. The aerosol-generating device may have an external diameter between 5 millimetres and 30 millimetres.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The housing may comprise at least one air inlet. The housing may comprise more than one air inlet.

The aerosol-generating device may comprise a heating element. The heating element may comprise at least one inductor coil for inductively heating one or more susceptors.

Operation of the heating element may be triggered by a puff detection system. Alternatively, the heating element may be triggered by pressing an on-off button, held for the duration of the user's puff. The puff detection system may be provided as a sensor, which may be configured as an airflow sensor to measure the airflow rate. The airflow rate is a parameter characterizing the amount of air that is drawn through the airflow path of the aerosol-generating device per time by the user. The initiation of the puff may be detected by the airflow sensor when the airflow exceeds a predetermined threshold. Initiation may also be detected upon a user activating a button. The sensor may also be configured as a pressure sensor.

The aerosol-generating device may include a user interface to activate the aerosol-generating device, for example a button to initiate heating of the aerosol-generating device or a display to indicate a state of the aerosol-generating device or of the aerosol-forming substrate.

The aerosol-generating device may include additional components, such as, for example a charging unit for recharging an on-board electric power supply in an electrically operated or electric aerosol-generating device.

As used herein, the term ‘proximal’ refers to a user-end, or mouth-end of the aerosol-generating device or system or a part or portion thereof, and the term ‘distal’ refers to the end opposite to the proximal end. When referring to the heating chamber, the term ‘proximal’ refers to the region closest to the open end of the cavity and the term ‘distal’ refers to the region closest to the closed end.

As used herein, the terms ‘upstream’ and ‘downstream’ are used to describe the relative positions of components, or portions of components, of the aerosol-generating device in relation to the direction in which a user draws on the aerosol-generating device during use thereof.

The term ‘airflow path’ as used herein denotes a channel suitable to transport gaseous media. An airflow path may be used to transport ambient air. An airflow path may be used to transport an aerosol. An airflow path may be used to transport a mixture of air and aerosol.

As used herein, a ‘susceptor’ or ‘susceptor element’ means an element that heats up when subjected to an alternating magnetic field. This may be the result of eddy currents induced in the susceptor element, hysteresis losses, or both eddy currents and hysteresis losses. During use, the susceptor element is located in thermal contact or close thermal proximity with an aerosol-forming substrate received in the aerosol-generating device or the aerosol-generating article. In this manner, the aerosol-forming substrate is heated by the susceptor such that an aerosol is formed.

The susceptor material may be any material that can be inductively heated to a temperature sufficient to aerosolize an aerosol-forming substrate. The following examples and features concerning the susceptor may apply to one or both of the susceptor element of the cartridge, a susceptor of an aerosol-generating device, and a susceptor of an aerosol-generating article. Suitable materials for the susceptor material include graphite, molybdenum, silicon carbide, stainless steels, niobium, aluminium, nickel, nickel containing compounds, titanium, and composites of metallic materials. Preferred susceptor materials comprise a metal or carbon. Advantageously the susceptor material may comprise or consists of a ferromagnetic or ferri-magnetic material, for example, ferritic iron, a ferromagnetic alloy, such as ferromagnetic steel or stainless steel, ferromagnetic particles, and ferrite. A suitable susceptor material may be, or comprise, aluminium. The susceptor material may comprise more than 5 percent, preferably more than 20 percent, more preferably more than 50 percent, or more than 90 percent of ferromagnetic, ferri-magnetic or paramagnetic materials. Preferred susceptor materials may be heated to a temperature in excess of 250 degrees Celsius without degradation.

The susceptor material may be formed from a single material layer. The single material layer may be a steel layer.

The susceptor material may comprise a non-metallic core with a metal layer disposed on the non-metallic core. For example, the susceptor material may comprise metallic tracks formed on an outer surface of a ceramic core or substrate.

The susceptor material may be formed from a layer of austenitic steel. One or more layers of stainless steel may be arranged on the layer of austenitic steel. For example, the susceptor material may be formed from a layer of austenitic steel having a layer of stainless steel on each of its upper and lower surfaces. The susceptor element may comprise a single susceptor material. The susceptor element may comprise a first susceptor material and a second susceptor material. The first susceptor material may be disposed in intimate physical contact with the second susceptor material. The first and second susceptor materials may be in intimate contact to form a unitary susceptor. In certain embodiments, the first susceptor material is stainless steel and the second susceptor material is nickel. The susceptor element may have a two-layer construction. The susceptor element may be formed from a stainless steel layer and a nickel layer.

Intimate contact between the first susceptor material and the second susceptor material may be made by any suitable means. For example, the second susceptor material may be plated, deposited, coated, clad or welded onto the first susceptor material. Preferred methods include electroplating, galvanic plating and cladding.

The aerosol-generating device may a power supply for powering the heating element. The power supply may comprise a battery. The power supply may be a lithium-ion battery. Alternatively, the power supply may be a nickel-metal hydride battery, a nickel cadmium battery, or a lithium-based battery, for example a lithium-cobalt, a lithium-iron-phosphate, lithium titanate or a lithium-polymer battery. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The power supply may be a direct current (DC) power supply. In one embodiment, the power supply is a DC power supply having a DC supply voltage in the range of 2.5 Volts to 4.5 Volts and a DC supply current in the range of 1 Amp to 10 Amps (corresponding to a DC power supply in the range of 2.5 Watts to 45 Watts). The aerosol-generating device may advantageously comprise a direct current to alternating current (DC/AC) inverter for converting a DC current supplied by the DC power supply to an alternating current. The DC/AC converter may comprise a Class-D, Class-C or Class-E power amplifier. The AC power output of the DC/AC converter is supplied to the induction coil.

The power supply may be adapted to power an inductor coil and may be configured to operate at high frequency. A Class-E power amplifier is preferable for operating at high frequency. As used herein, the term ‘high frequency oscillating current’ means an oscillating current having a frequency of between 500 kilohertz and 30 megahertz. The high frequency oscillating current may have a frequency of from 1 megahertz to 30 megahertz, preferably from 1 megahertz to 10 megahertz, and more preferably from 5 megahertz to 8 megahertz.

In another embodiment the switching frequency of the power amplifier may be in the lower kHz range, e.g. between 100 kHz and 400 KHz. In the embodiments, where a Class-D or Class-C power amplifier is used, switching frequencies in the lower kHz range are particularly advantageous.

The aerosol-generating device may comprise a controller. The controller may be electrically connected to the inductor coil. The controller may be electrically connected to the first induction coil and to the second induction coil. The controller may be configured to control the electrical current supplied to the induction coil(s), and thus the magnetic field strength generated by the induction coil(s).

The power supply and the controller may be connected to the inductor coil(s).

The controller may be configured to be able to chop the current supply on the input side of the DC/AC converter. This way the power supplied to the inductor coil(s) may be controlled by conventional methods of duty-cycle management.

Below, there is provided a non-exhaustive list of non-limiting examples. Any one or more of the features of these examples may be combined with any one or more features of another example, embodiment, or aspect described herein.

Example A: An aerosol-generating article for use with an aerosol-generating device, comprising
a susceptor element comprising a hollow tubular proximal region and a closed distal end; and
a hollow tubular wick element coaxially circumscribing at least a portion of the hollow tubular proximal region of the susceptor element.

Example B: The article according to Example A, wherein the closed distal end is configured as a cup-shaped distal end region.

Example C: The article according to Example B, wherein the cup-shaped distal end region provides a collecting reservoir for collecting condensed liquid droplets.

Example D: The assembly according to any of the preceding examples, wherein at least a portion of the susceptor element, preferably at least a portion of the hollow tubular proximal region of the susceptor element, is fluid permeable, more preferably, wherein at least a portion of the hollow tubular proximal region of the susceptor element is fluid permeable and the closed distal end is fluid impermeable.

Example E: The article according to Example D, wherein one or both of the hollow tubular proximal region and the closed distal end of the susceptor element comprises a porous material.

Example F: The article according to Example E, wherein the porous material has a porosity of 45% to 80%, preferably 55% to 70%.

Example G: The article according to Example E or Example F, wherein the porous material is a ferromagnetic alloy, preferably a ferromagnetic stainless steel alloy, more preferably 304 stainless steel, or 410 stainless steel.

Example H: The article according to any of the preceding examples, wherein the hollow tubular proximal region and the closed distal end of the susceptor element form a monolithic structure.

Example I: The article according to any of the preceding examples, comprising an airflow path extending along a longitudinal center axis of the hollow tubular proximal region of the susceptor element.

Example J: The article according to any of the preceding examples, comprising one or more air inlets located at a position proximal to the closed distal end.

Example K: The article according to Example J, wherein the size, number, and arrangement of the one or more air inlets is configured to predetermine the overall resistance to draw of the article.

Example L: The article according to Example K, wherein the one or more air inlets are arranged such that the overall resistance to draw of the article is in the range of between 50 to 200 mm of water, preferably between 100 and 160 mm of water, more preferably between 120 and 140 mm of water.

Example M: The article according to any of the preceding examples, comprising a hollow tubular liquid storage portion coaxially circumscribing the wick element.

Example N: The article according to Example M, wherein the hollow tubular liquid storage portion comprises a high-retention material adjacent to a side wall of the wick element.

Example O: The article according to Example N, comprising a porous wall element provided at an interface between the high-retention material and the wick element.

Example P: The article according to any of the preceding examples, comprising a mouthpiece element.

Example Q: The article according to Example P, wherein the mouthpiece element comprises one or more peelable outer layers.

Example R: The article according to any of the preceding examples, wherein the article has a cylindrical shape, and wherein an outer diameter of the article is between 5 millimeters to 10 millimeters, preferably between 6 millimeters to 8 millimeters.

Example S: The article according to any of the preceding examples, wherein the closed distal end is fluid impermeable.

Example T: An aerosol-generating system, comprising
an article according to any of the preceding examples; and
an aerosol-generating device, comprising a heating chamber for insertion of at least a portion of the article and an inductor coil at least partly circumscribing the heating chamber for inductively heating the article.

Features described in relation to one embodiment may equally be applied to other embodiments of the invention.

The invention will be further described, by way of example only, with reference to the accompanying drawings in which:

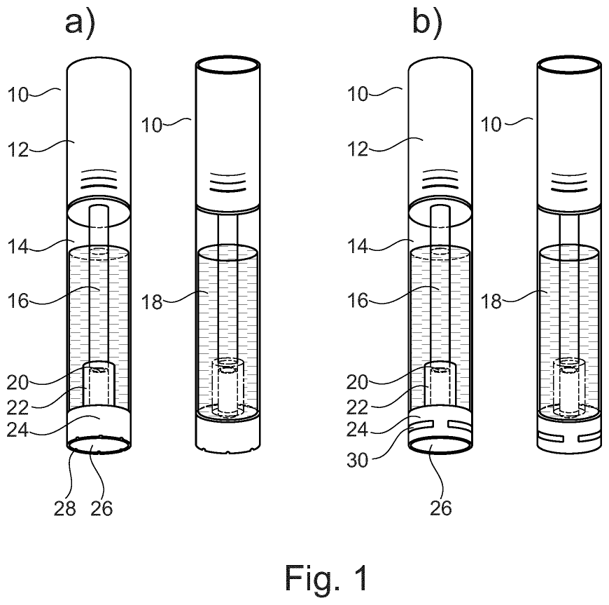

FIG. 1a shows an aerosol-generating article;

FIG. 1b shows an aerosol-generating article;

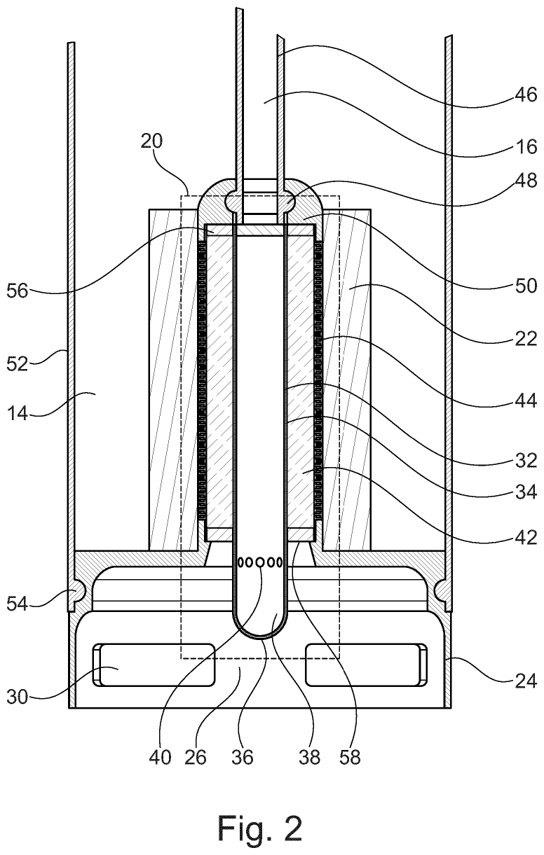

FIG. 2 shows a portion of an aerosol-generating article;

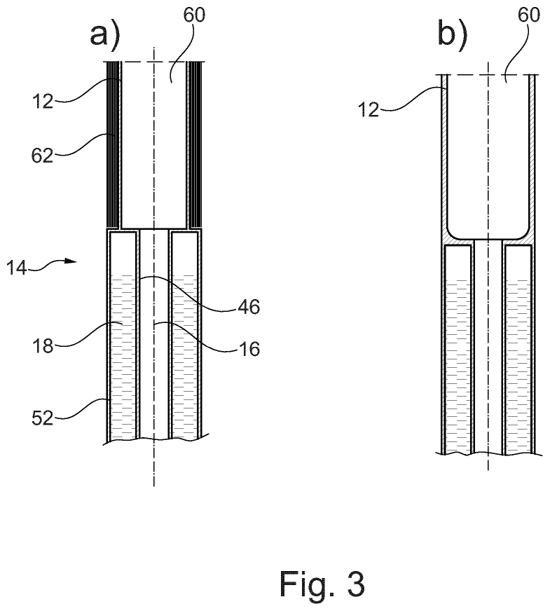

FIG. 3a shows a mouthpiece element;

FIG. 3b shows a mouthpiece element; and

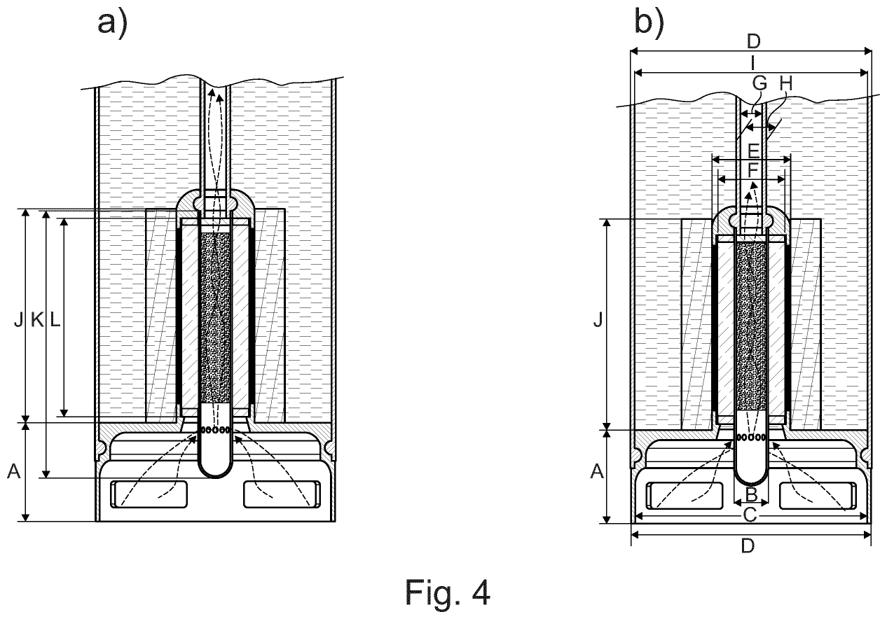

FIGS. 4a and 4b show a portion of an aerosol-generating article.

FIG. 1a shows two perspective views of an elongate cylindrical aerosol-generating article 10. The article 10 comprises a mouthpiece element 12 arranged at a proximal end of the article 10. The article 10 further comprises cartridge section. The cartridge section comprises a hollow tubular liquid storage portion 14 circumscribing an inner channel 16. The hollow tubular liquid storage portion 14 holds a liquid aerosol-forming substrate 18. The cartridge section comprises a susceptor-and-wick assembly 20 which is arranged in the inner channel 16 and which is circumscribed by the liquid storage portion 14. The susceptor-and-wick assembly 20 is described in more detail with respect to FIG. 2 below. The hollow tubular liquid storage portion 14 comprises a high-retention material 22 adjacent to a side wall of the susceptor-and-wick assembly 20.

The article 10 comprises a capping element 24 arranged at a distal end thereof. The capping element 24 comprises a hollow tubular wall element 26. The capping element 24 comprises a plurality of recesses 28 circumferentially arranged at a distal end of the hollow tubular wall element 26.

FIG. 1b shows two perspective views of an aerosol-generating article 10. The article 10 shown in FIG. 1b is identical to the article 10 of FIG. 1a with the exception that the capping element 24 of FIG. 1b does not comprises recesses 28. Instead, the capping element 24 of FIG. 1b comprises a plurality of elongate openings 30 circumferentially arranged in the hollow tubular wall element 26.

The recesses 28 or the elongate openings 30 may allow for ambient air to enter the article at its distal end thereof when the article is brought into contact to a planar surface, for example, when the article is inserted into a heating chamber of an aerosol-generating device and against a plane distal base of the heating chamber.

FIG. 2 shows a distal portion of the aerosol-generating article of FIG. 1b. The susceptor-and-wick assembly 20 is shown in more detail. The area of the susceptor-and-wick assembly 20 is highlighted by a dotted rectangle for illustrative purposes.

The susceptor-and-wick assembly 20 comprises a susceptor element 32. The susceptor element 32 comprises a hollow tubular proximal region 34 and a closed distal end. The closed distal end is configured as a cup-shaped distal end region 36. The cup-shaped distal end region 36 provides a collecting reservoir 38 for collecting condensed liquid droplets.

The susceptor element 32 comprises a plurality of air inlets 40 located at a position proximal to the closed cup-shaped distal end region 36. The size, number, and arrangement of the air inlets 40 is configured to predetermine the overall resistance to draw of the article.

The susceptor-and-wick assembly 20 comprises a hollow tubular wick element 42 coaxially circumscribing a major portion of the hollow tubular proximal region 34 of the susceptor element 32 with the exception of a distal portion thereof which comprises the air inlets 40.

At least the major portion of the hollow tubular proximal region 34 which is circumscribed by the wick element 42 is fluid permeable. The entire susceptor element 32 comprising the tubular proximal region 34 and the cup-shaped distal end region 36 may be a monolithic structure. The monolithic structure may be fluid permeable. The monolithic structure may be porous. The monolithic structure may comprise a fluid impermeable coating int the area of the cup-shaped distal end region 36.

The hollow tubular liquid storage portion 14 coaxially circumscribes the wick element 42. The hollow tubular liquid storage portion 14 comprises the high-retention material 22 adjacent to a side wall of the wick element 42. A porous, fluid permeable inner wall element 44 is provided at an interface between the high-retention material 22 and the wick element 42.

The liquid aerosol-forming substrate 18 stored in the liquid storage portion 14 may migrate into and through the high-retention material 22, then through the fluid permeable inner wall element 44 and into and through the wick element 42 to wet the hollow tubular proximal region 34 of the susceptor element 32. When the susceptor element 32 is inductively heated, the liquid aerosol-forming substrate 18 located at the hollow tubular proximal region 34 may be heated to volatilize to form an aerosol.

The cup-shaped distal end region 36 of the susceptor element 32 provides a mechanism for leakage prevention. Liquid droplets which may be present inside the hollow tubular proximal region 34, for example, due to a portion of liquid aerosol-forming substrate that has not been evaporated, may travel towards the cup-shaped distal end region 36 by gravity or capillary forces. The liquid droplets are then be trapped in the collecting reservoir 38. Thereby, leakage may be avoided.

In a region proximal to the susceptor-and-wick assembly 20, a fluid impermeable inner wall element 46 of the liquid storage portion 14 circumscribes the inner channel 16. A distal end of the fluid impermeable inner wall 46 comprises first protrusions 48. A proximal end portion 50 of the susceptor-and-wick-assembly 20 is fastened and sealed to the fluid impermeable inner wall 46 via the first protrusions 48.

The capping element 24 is fastened and sealed by fixing its tubular wall element 26 to an outer wall 52 of the liquid storage portion 14 via second protrusions 54. Instead of the elongate openings 30, the capping element 74 may comprise recesses 28 as shown in FIG. 1a.

A proximal sealing element 56 in form of a sealing disk is provided at a proximal end of the wick element 42. A distal sealing element 58 in form of a sealing disk is provided at a distal end of the wick element 42. The distal sealing element 56 blocks air, and retains and assembles the susceptor element 32 and the wick element 42.

The article 10 comprises an airflow path extending along a longitudinal center axis of the hollow tubular proximal region 34 of the susceptor element 32. Air may enter the article 10 at the distal end through elongate openings 30 and may further enter the airflow path within the susceptor element 32 via air inlets 40. Incoming air may be preheated when coming into proximity to the hot susceptor element 32 and when entering the hollow susceptor element 32 via air inlets 40. In the region of the axis of the hollow tubular proximal region 34, an aerosol forms when the susceptor element 32 is inductively heated to volatize the liquid aerosol-forming substrate migrated to the susceptor element 32. The airflow route is visualized by dotted arrows in FIGS. 4a and 4b. The airflow comprising the volatized compounds of the aerosol-forming substrate further travels through the inner channel 16 and into mouthpiece 12 where the ripened aerosol exits the article to be inhaled by a user.

FIGS. 3a and 3b each show a mouthpiece element 12 mounted on top of the proximal end of a cartridge section of the aerosol-generating article 10. The proximal part of the hollow tubular liquid storage portion 14, inner channel 16, liquid aerosol-forming substrate 18, and outer wall 52 are shown. The mouthpiece elements 12 comprise a homogenization chamber 60. The homogenization chamber 60 is in fluid connection to the inner channel 16. The homogenization chamber 60 enables expansion, homogenization and cooling of the aerosol before it exits the mouthpiece element 12 for inhalation by a user.

In difference to the mouthpiece element 12 of FIG. 3b, an outer sidewall of the mouthpiece element 12 of FIG. 3a comprises a multilayer of peelable outer layers 60. Each layer of the peelable outer layers 62 is releasably adhered onto an adjacent inner layer. The individual layers thus provide segments which can be individually peeled off. Thereby, a hygienic mouthpiece is provided.

After a usage of the article, a used layer may be peeled off such that a clean surface is present for the next usage or the next user.

FIGS. 4a and 4b show cross-sectional views of a portion of an aerosol-generating article as similarly shown in FIG. 2. As indicated above, the airflow path is visualized by dotted arrows.

Further, in FIGS. 4a and 4b, suitable ranges of lengths and preferred lengths of specific parts are indicated. Corresponding values are listed in Table 1 below.

TABLE 1
suitable dimensions of article components
as indicated in in FIGS. 4a and 4b.

| | range | preferred range |
|---|---|---|
| part | in millimeters | in millimeters |
| A | 2-9 | 3-7 |
| B | 1.7-5 | 2-4 |
| C | 4-7 | 6-7 |
| D | 5-10 | 6-8 |
| E | 3-7 | 4-5 |
| F | 2.5-6.5 | 3.5-4.5 |
| G | 2.5-6.7 | 2.5-5.5 |
| H | 1.5-5.5 | 2-4.5 |
| I | 4.5-9 | 5.5-7.5 |
| J | 4-20 | 6-13 |
| K | 7-32 | 9-26 |
| L | 3-17 | 5-11 |

1. An aerosol-generating article for use with an aerosol-generating device, comprising
a susceptor element comprising a hollow tubular proximal region and a closed distal end; and
a hollow tubular wick element coaxially circumscribing at least a portion of the hollow tubular proximal region of the susceptor element.

2. The article according to claim 1, wherein the closed distal end is configured as a cup-shaped distal end region.

3. The article according to claim 2, wherein the cup-shaped distal end region provides a collecting reservoir for collecting condensed liquid droplets.

4. The article according to claim 1, wherein at least a portion of the susceptor element is fluid permeable.

5. The article according to claim 4, wherein one or both of the hollow tubular proximal region and the closed distal end of the susceptor element comprises a porous material.

6. The article according to claim 5, wherein the porous material has a porosity of 45% to 80%.

7. The article according to claim 1, comprising an airflow path extending along a longitudinal center axis of the hollow tubular proximal region of the susceptor element.

8. The article according to claim 1, comprising one or more air inlets located at a position proximal to the closed distal end.

9. The article according to claim 8, wherein the size, number, and arrangement of the one or more air inlets is configured to predetermine an overall resistance to draw of the article, and wherein the one or more air inlets are arranged such that the overall resistance to draw of the article is in a range of between 50 to 200 mm of water.

10. The article according to claim 1, comprising a hollow tubular liquid storage portion coaxially circumscribing the wick element.

11. The article according to claim 10, wherein the hollow tubular liquid storage portion comprises a high-retention material adjacent to a side wall of the wick element.

12. The article according to claim 11, comprising a porous wall element provided at an interface between the high-retention material and the wick element.

13. The article according to claim 1, wherein the article has a cylindrical shape, and wherein an outer diameter of the article is between 5 millimeters to 10 millimeters, preferably between 6 millimeters to 8 millimeters.

14. The article according to claim 1, wherein the closed distal end is fluid impermeable.

15. An aerosol-generating system, comprising
an article according to claim 1; and
an aerosol-generating device, comprising a heating chamber for insertion of at least a portion of the article and an inductor coil at least partly circumscribing the heating chamber for inductively heating the article.

16. The article according to claim 1, wherein at least a portion of the hollow tubular proximal region of the susceptor element is fluid permeable.

17. The article according to claim 1, wherein at least a portion of the hollow tubular proximal region of the susceptor element is fluid permeable and the closed distal end is fluid impermeable.

18. The article according to claim 5, wherein the porous material has a porosity of 55% to 70%.

19. The article according to claim 8, wherein the size, number, and arrangement of the one or more air inlets is configured to predetermine an overall resistance to draw of the article, and wherein the one or more air inlets are arranged such that the overall resistance to draw of the article is in a range of between 100 and 160 mm of water.

20. The article according to claim 1, wherein the article has a cylindrical shape, and wherein an outer diameter of the article is between between 6 millimeters to 8 millimeters.
